(19) United States
(12) Patent Application Publication
(10) Pub. No.: US 2024/0382925 A1
(43) Pub. Date: Nov. 21, 2024

(54) METHOD OF PREPARING CESIUM ADSORBENT AND CESIUM ADSORBENT PREPARED THEREBY

(71) Applicant: PUKYONG NATIONAL UNIVERSITY INDUSTRY-UNIVERSITY COOPERATION FOUNDATION, Busan (KR)

(72) Inventors: Min Hee LEE, Busan (KR); So Young JEON, Busan (KR); Min June YANG, Busan (KR)

(73) Assignee: PUKYONG NATIONAL UNIVERSITY INDUSTRY-UNIVERSITY COOPERATION FOUNDATION, Busan (KR)

(21) Appl. No.: 18/655,837

(22) Filed: May 6, 2024

(30) Foreign Application Priority Data
May 18, 2023 (KR) 10-2023-0064400

(51) Int. Cl. B01J 20/04

(52) U.S. Cl. CPC B01J 20/045; B01J 2220/4887

(57) ABSTRACT

Proposed are a method of preparing a cesium adsorbent and a cesium adsorbent prepared thereby. The method includes (a) preparing a powder mixture of coal mine drainage sludge (CMDS) powder, sodium hydroxide (NaOH) powder, and sulfur (S) powder and (b) heat-treating the powder mixture to prepare a cesium adsorbent. The cesium adsorbent increases the active ion exchange of Na and Cs and the bonding of S—Cs when adsorbing cesium ions, resulting in an average of 5 times higher Cs removal efficiency and adsorption capacity under various conditions compared to CMDS since CMDS relies on cesium adsorption by simple physical and electrostatic attraction. Moreover, the cesium adsorbent is eco-friendly and has excellent economic efficiency by utilizing waste CMDS.

### CROSS REFERENCE TO RELATED APPLICATION

The present application claims priority to Korean Patent Application No. 10-2023-0064400, filed May 18, 2023, the entire contents of which is incorporated herein for all purposes by this reference.

### BACKGROUND OF THE DISCLOSURE

### 1. Field of the Disclosure

The present disclosure relates to a method of preparing an adsorbent for the removal of cesium (Cs) ions contained in radioactive wastewater, and to a cesium adsorbent prepared thereby.

### 2. Description of the Related Art

Most of the low-level and medium-level radioactive waste generated from nuclear power plants includes medium-lived and long-lived nuclides (for example, ⁶⁰Cs, ¹³⁷Cs, or ⁹⁰Sr), large amounts of non-radioactive chemical species (for example, Na, K, and B), and short-lived nuclides.

In particular, ¹³⁷Cs is one of the most abundant radio-nuclides present in radioactive liquid waste. ¹³⁷Cs has a very long half-life of about 30 years and has very high solubility, making ¹³⁷Cs one of the nuclides that requires the most attention in radioactive waste disposal. ¹³⁷Cs has chemically similar properties to potassium (K) when absorbed into the human body, so ¹³⁷Cs is easily absorbed by living organisms. Thus, ¹³⁷Cs is known to cause serious damage to human health and the environment. Processing issues such as separation or removal of Cs with these properties have been given a continuous interest.

Currently, the treatment of low-level and medium-level radioactive liquid waste generated from the nuclear industry in Korea varies greatly from power plant to power plant. In addition, different treatment processes are used depending on the properties of the waste. However, treatment is basically performed by evaporating and concentrating waste using a waste liquid evaporator and then solidifying the waste using paraffin as a solidifying agent.

The method is very effective in concentrating waste, but the reduction effect is reduced due to the method involving concentrating all solids without distinction between nuclides and non-nuclides. In addition, high operating costs are required due to heat treatment. Moreover, organic matters form a bubble scale inside the evaporator. Due to that, the performance of the evaporator is reduced, and maintenance is frequent, resulting in increasing operating costs, as well as continuous operation is disrupted. Thus, research is being actively conducted on methods for the disposal of radioactive waste liquid to solve such problems.

In particular, the adsorption of radio-nuclides through ion exchange has various advantages such as convenience, efficiency, and low cost. By an ion exchange method using various inorganic ion exchangers such as zeolite, titanosilicate, metal oxide, hexacyanoferrate, modified clays, or synthetic clays, a technology has been developed to adsorb and treat radio-nuclides such as cesium contained in radioactive waste fluid.

### RELATED ART DOCUMENT

### Patent Document

(Patent document 1) Japanese Patent Application Publication No. 2015-174009 (Publication date: 2015 Oct. 5)

### SUMMARY OF THE DISCLOSURE

The technical problems to be solved by the present disclosure is to provide a method of preparing a new cesium adsorbent that is environmentally friendly and has improved adsorption performance by recycling waste, and a cesium adsorbent prepared thereby.

To solve the technical problems, a method of preparing a cesium adsorbent is proposed, the method including:
(a) preparing a powder mixture of coal mine drainage sludge (CMDS) powder, sodium hydroxide (NaOH) powder, and sulfur (S) powder; and
(b) heat-treating the powder mixture to prepare a cesium adsorbent.

In the preparing of the powder mixture, to prepare a cesium adsorbent based on coal mine drainage sludge (CMDS) to which sodium (Na) and sulfur (S) were added, coal mine drainage sludge (CMDS) powder, sodium hydroxide (NaOH) powder, and sulfur (S) powder are uniformly stirred to prepare a powder mixture thereof.

A coal mine drainage sludge (CMDS) refers to a sludge precipitated after neutralizing with an alkaline substance mine waste including sulfide minerals or acid mine drainage generated from a mine shaft. A sludge generated in mining areas is basically rich in iron (Fe), manganese (Mn), and aluminum (Al) derived from mine drainage. When sludge goes through a neutralization process, the calcium (Ca) content and alkali element content also appear high. Therefore, a coal mine drainage sludge is known as a cesium adsorbent that converts cesium ions (Cs⁺) into a stable material by adsorbing or precipitating cesium ions on the surface.

The sodium hydroxide (NaOH) powder is included in the powder mixture to introduce sodium (Na) into coal mine drainage sludge (CMDS). In cesium adsorption through ion exchange, hydrated cations of similar size to cesium ions are used in a cation exchange reaction, enabling an increase in the adsorption capacity of cesium. Sodium ions (Na⁺) have a very similar hydration radius (Cs⁺: 0.329 nm, Na⁺: 0.358 nm) to cesium ions (Cs⁺), so a very easy cation exchange reaction between the two ions can be expected.

In addition, the sulfur (S) powder is included in the powder mixture to introduce sulfur (S) into coal mine drainage sludge (CMDS). Based on the Lewis acid-base theory, hard acids have a high affinity with hard bases, and soft acids have a high affinity with soft bases (hard soft acid base (HSAB) theory). By the theory, cesium (Cs), a soft acid, and sulfur (S), a soft base, have a high affinity. Cesium ions have the properties of the softest acid among competing alkaline and alkaline earth cations, thereby sulfur (S) is expected to increase not only the adsorption capacity of cesium (Cs) but also the selectivity for cesium (Cs) among competing cations.

Meanwhile, in the step, the powder mixture can include 50 to 150 parts by mass of sodium hydroxide (NaOH) powder and 20 to 60 parts by mass of sulfur (S) powder based on 100 parts by mass of coal mine drainage sludge (CMDS) powder.

For example, the powder mixture can include coal mine drainage sludge (CMDS) powder, sodium hydroxide (NaOH) powder, and sulfur (S) powder in a mass ratio of 1:1:0.4.

Next, in the heat-treating, a cesium adsorbent (Na—S-CMDS) with sodium (Na) and sulfur (S) introduced into coal mine drainage sludge (CMDS) is synthesized by heat-treating the powder mixture of the coal mine drainage sludge (CMDS), sodium hydroxide (NaOH), and sulfur (S).

In the step, the heat treatment to synthesize the cesium adsorbent (Na—S-CMDS) can be performed under a reducing or inert atmosphere at a temperature in a range of 300° C. to 500° C. for 1 to 10 hours.

For example, in the step, the cesium adsorbent (Na—S-CMDS) can be synthesized by heat-treating the powder mixture at a temperature of 400° C. for 2 hours.

Furthermore, to minimize the elution of sodium (Na) and sulfur (S) from the cesium adsorbent (Na—S-CMDS) prepared above and to increase the stability of the adsorbent, the present disclosure may further involve washing the cesium adsorbent with water.

In another aspect of the disclosure, the present disclosure proposes a cesium adsorbent prepared by the preparation method.

According to the present disclosure, a new cesium adsorbent (Na—S-CMDS) is synthesized by adding sodium (Na) and sulfur (S) to coal mine drainage treatment sludge (CMDS) previously used as a cesium (Cs) adsorbent. The cesium adsorbent increases the active ion exchange of Na and Cs and the bonding of S—Cs when adsorbing cesium ions, resulting in an average of 5 times higher Cs removal efficiency and adsorption capacity under various conditions compared to CMDS since CMDS relies on cesium adsorption by simple physical and electrostatic attraction.

In addition, the cesium adsorbent prepared according to the present disclosure is eco-friendly because the cesium adsorbent utilizes CMDS, which is a waste product. Moreover, the cesium adsorbent is more economical than conventional expensive cesium adsorbents.

### BRIEF DESCRIPTION OF THE DRAWINGS

FIG. 1 is a schematic diagram sequentially showing each step of the process for preparing a cesium adsorbent (Na—S-CMDS) in an embodiment of the present application.

### DESCRIPTION OF THE PREFERRED EMBODIMENTS

In describing the present disclosure, when it is determined that a detailed description of a related known function or configuration may unnecessarily obscure the gist of the present disclosure, the detailed description will be omitted.

The example according to the concept of the present disclosure may be subject to various changes and may have various forms. Thus, a specific example is illustrated in the drawing and described in detail in the specification or application. However, this is not intended to limit the example according to the concept of the present disclosure to a specific disclosed form. It should be understood that all changes, equivalents, and substitutes included in the spirit and technical scope of the present disclosure are included.

The terms used in this specification are merely used to describe a specific example and are not intended to limit the disclosure. Singular expressions include plural expressions unless the context clearly dictates otherwise. In this specification, terms such as “include” or “have” are intended to indicate the presence of described features, numbers, steps, operations, components, parts, or combinations thereof. The terms should be understood as not precluding the presence or addition of one or more other features, numbers, steps, operations, components, parts, or combinations thereof.

Hereinafter, the present disclosure will be described in more detail through the example.

The example according to the present specification may be modified into various other forms, and the scope of the present specification is not to be construed as being limited to the example detailed below. The example of this specification is provided to completely explain the present specification to those with average knowledge in the art.

### Example

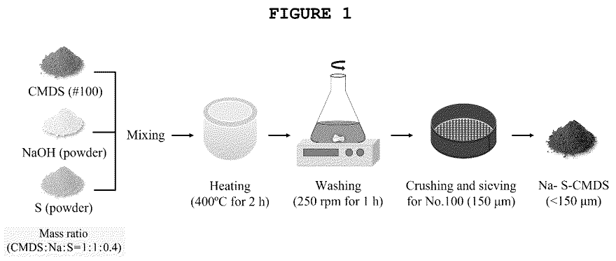

As shown in FIG. 1, 50 g of coal mine drainage treatment sludge (CMDS), 50 g of sodium hydroxide (NaOH), and 20 g of sulfur (S) at a mass ratio of 1:1:0.4 were prepared in powder form using a mortar and pestle and mixed evenly to prepare a cesium adsorbent (Na—S-CMDS) according to the present disclosure. The mixture was placed in a crucible, heat-treated in an electric furnace for 2 hours from the time the electric furnace reached the temperature of 400° C., and then slowly cooled to room temperature to obtain a cesium adsorbent (Na—S-CMDS).

The Na—S-CMDS sample was prepared in powder form using a mortar and pestle. Afterward, to minimize the elution of sodium (Na) and sulfur (S) and increase the stability of the adsorbent, with the ratio of Na—S-CMDS powder and distilled water set to 1:50, the Na—S-CMDS powder was washed at a speed of 250 rpm for 1 hour using a magnetic stirrer.

The washed sample was filtered using a vacuum filter and completely dried in an oven at a temperature of 40° C., and then analyses of physicochemical and mineralogical properties were performed on the sample filtered through a No. 100 sieve (diameter <150 μm).

As a result of identifying the physicochemical and mineralogical properties of Na—S-CMDS, it was confirmed that the sample has mineralogical properties and shapes that are favorable for Cs adsorption.

To evaluate the Cs adsorption efficiency and adsorption capacity of Na—S-CMDS in a water system, adsorption batch experiments (adsorbent input amount, initial concentration of Cs, and adsorption reaction time), adsorption kinetics and isotherm modeling were conducted. As a result, the sample reached equilibrium within 1 hour and showed high Cs removal efficiency (90%), especially in the low concentration range (<0.5 mg/L), and the modeling results tended to be consistent with the pseudo-second-order kinetic equation and the Langmuir adsorption isotherm.

The cesium adsorbent (Na—S-CMDS) prepared according to the present disclosure is significant in that it is an eco-friendly cesium adsorbent that complements the disadvantages of low Cs removal efficiency from seawater or groundwater with high ionic strength and reduced removal efficiency in low concentration ranges.

The present disclosure is not limited to the above example and can be prepared in various forms. Those skilled in the art to which the present disclosure pertains will understand that the present disclosure can be implemented in other specific forms without changing its technical idea or essential features. Therefore, the example described above should be understood in all respects as illustrative and not restrictive.

What is claimed is:

1. A method of preparing a cesium adsorbent, the method comprising:
(a) preparing a powder mixture of coal mine drainage sludge (CMDS) powder, sodium hydroxide (NaOH) powder, and sulfur (S) powder; and
(b) heat-treating the powder mixture to prepare a cesium adsorbent.

2. The method of claim 1, wherein, in the preparing of the powder mixture, the powder mixture is prepared by mixing the coal mine drainage sludge (CMDS) powder, the sodium hydroxide (NaOH) powder, and the sulfur (S) powder in a mass ratio of 1:1:0.4.

3. The method of claim 1, wherein, in the heat-treating, the powder mixture is heat treated at a temperature of 400° C. for 2 hours.

4. The method of claim 1, further comprising:
(c) washing the cesium adsorbent resulting from the heat-treating, with water.

5. A cesium adsorbent prepared by the method according to claim 1.
